(19) United States
(12) Patent Application Publication
(10) Pub. No.: US 2025/0291655 A1
(43) Pub. Date: Sep. 18, 2025

(54) WEBCAM AND DATA PROCESSING METHOD THEREOF

(71) Applicant: REALTEK SEMICONDUCTOR CORP., HSINCHU (TW)

(72) Inventors: Lin-Lin Yu, Jiangsu Province (CN); Wei Wang, Jiangsu Province (CN); Rong-Yan Xiong, Jiangsu Province (CN); Jiang-Tao Nie, Jiangsu Province (CN)

(21) Appl. No.: 18/953,817

(22) Filed: Nov. 20, 2024

(30) Foreign Application Priority Data
Mar. 18, 2024 (CN) 202410308996.6

(51) Int. Cl. G06F 9/54; G06F 3/16; G06F 13/40

(52) U.S. Cl. CPC G06F 9/546; G06F 3/162; G06F 13/4027

(57) ABSTRACT

A webcam and a data processing method thereof are provided. The webcam includes a processing circuit and a storage circuit. The processing circuit is electrically connected to the storage circuit. The processing circuit accesses the storage circuit to execute a first operating system, a second operating system, and a peer-to-peer proxy module. The first operating system collects a plurality of data packets, the peer-to-peer proxy module operates under the first operating system, and the second operating system is configured to act as a virtual network card for connecting to an external network. The first operating system includes a first virtual network port, the second operating system includes a second virtual network port, and the first virtual network port is connected to the second virtual network port.

### CROSS-REFERENCE TO RELATED PATENT APPLICATION

This application claims the benefit of priority to China Patent Application No. 202410308996.6, filed on Mar. 18, 2024, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a networking device and a data processing method thereof, and more particularly to a webcam and a data processing method thereof.

### BACKGROUND OF THE DISCLOSURE

Existing webcams can be divided into single-operating system devices and dual-operating system devices. The single-operating system device needs to implement all functions of the webcam on the Linux operating system. As for the dual-operating system device, the Linux operating system and the Internet of Things (IoT) operating system divide up the work. The Linux operating system is responsible for collection and processing of audio and video data, and the Internet of Things operating system is responsible for network transmission.

A private protocol is defined between the Linux operating system and the IoT operating system. Through the private protocol, the Linux operating system transmits the collected audio and video data to the IoT operating system. Then, in the environment of the IoT operating system, a peer-to-peer proxy executes transmission of the audio and video data to a cloud network. In this way, mobile communication devices connected to the cloud network can receive the audio and video data from the webcam.

Since the IoT operating system is a niche operating system, relevant maintenance personnel are few in number. Accordingly, there are fewer libraries provided by third parties, thereby causing development of the IoT operating system to be relatively difficult.

### SUMMARY OF THE DISCLOSURE

In response to the above-referenced technical inadequacy, the present disclosure provides a webcam and a data processing method thereof.

In order to solve the above-mentioned problem, one of the technical aspects adopted by the present disclosure is to provide a webcam. The webcam includes a processing circuit and a storage circuit. The processing circuit is electrically connected to the storage circuit. The processing circuit accesses the storage circuit to execute a first operating system, a second operating system, and a peer-to-peer proxy module. The first operating system collects a plurality of data packets, the peer-to-peer proxy module operates under the first operating system, and the second operating system is configured to act as a virtual network card for connecting to an external network. The first operating system includes a first virtual network port, the second operating system includes a second virtual network port, and the first virtual network port is connected to the second virtual network port by physical connection.

In order to solve the above-mentioned problem, another one of the technical aspects adopted by the present disclosure is to provide a data processing method of a webcam. The data processing method includes: configuring a processing circuit to access a storage device to execute a first operating system, a second operating system, and a peer-to-peer proxy module, in which the peer-to-peer proxy module operates under the first operating system; collecting, by the first operating system, a plurality of data packets; configuring a first virtual network port on the first operating system; configuring the second operating system as a virtual network card for connecting to an external network; configuring a second virtual network port on the second operating system; and connecting the first virtual network port and the second virtual network port by physical connection.

Therefore, in the webcam and the data processing method thereof provided by the present disclosure, there is no need to additionally define a private protocol between the first operating system and the second operating system, and bidirectional data transmission can also be performed between the first operating system and the second operating system. Since the peer-to-peer proxy module does not operate under the second operating system, the second operating system is only responsible for the network card function. In this way, the division of labor between the first operating system and the second operating system is clear, which can reduce development difficulties and shorten a development cycle.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a webcam according to a first embodiment of the present disclosure;

FIG. 2 is a schematic diagram of the webcam according to a second embodiment of the present disclosure;

FIGS. 3A and 3B show a flowchart of a data processing method of the webcam according to the first embodiment of the present disclosure;

FIGS. 4A and 4B show a flowchart of the data processing method of the webcam according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

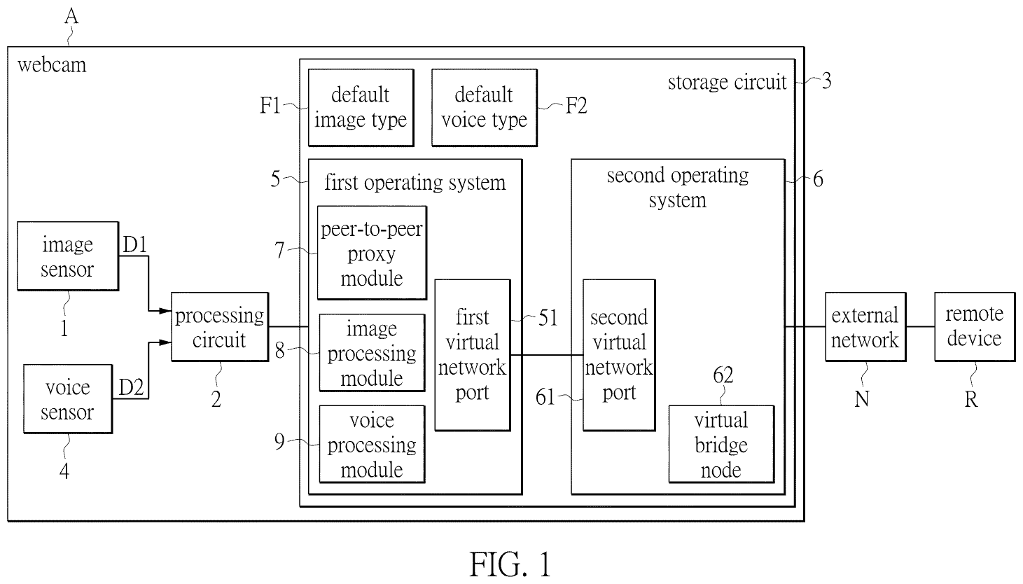

FIG. 1 is a schematic diagram of a webcam according to a first embodiment of the present disclosure. Referring to FIG. 1, a webcam A includes an image sensor 1, a processing circuit 2, a storage circuit 3, and a voice sensor 4. The image sensor 1 is, for example, a charge coupled device (CCD) sensor or a complementary metal-oxide semiconductor (CMOS) sensor. The processing circuit 2 is, for example, one or any combination of a central processing unit, an application-specific integrated circuit, a field programmable gate array, and a system-on-chip. The storage circuit 3 is, for example, a programmable read-only memory, an erasable programmable read-only memory, or a flash memory. The voice sensor 4 is, for example, an omnidirectional microphone or a bidirectional microphone.

The image sensor 1 is electrically connected to the processing circuit 2, and the image sensor 1 is configured to capture a plurality of image data packets D1.

The storage circuit 3 and the voice sensor 4 are electrically connected to the processing circuit 2, and the voice sensor 4 is configured to capture a plurality of voice data packets D2.

The processing circuit 2 is electrically connected to the storage circuit 3. The processing circuit 2 accesses the storage circuit 3 to execute a first operating system 5, a second operating system 6, a peer-to-peer proxy module 7, an image processing module 8, and a voice processing module 9. The first operating system 5 is, for example, a Linux operating system, and the second operating system 6 is, for example, an Internet of Things (IoT) operating system. The Internet of Things operating system is, for example, freertos, ucos, rt-thread, or zephyr, but the present disclosure is not limited thereto.

The peer-to-peer proxy module 7 operates under the first operating system 5, and the second operating system 6 is configured as a virtual network card for connecting to an external network N. A remote device R is connected to the external network N, and the remote device R is, for example, a mobile communication device, a laptop, or a cloud server. In addition to receiving data from the webcam A, the remote device R can also issue control instructions to start or shut down the webcam A, or command the webcam A to rotate in a specified direction.

The first operating system 5 includes a first virtual network port 51, and the first virtual network port 51 is a network interface.

The first operating system 5 is configured to collect the plurality of image data packets D1. The image processing module 8 operates under the first operating system 5 to perform image processing on the plurality of image data packets D1. The image processing includes one or any combination of image enhancement, image encoding and decoding, image wavelet processing, resolution processing, color processing, and object recognition.

The first operating system 5 is configured to collect the plurality of voice data packets D2. The voice processing module 9 operates under the first operating system 5 to perform voice processing on the plurality of voice data packets D2. The voice processing includes one or any combination of speech quantization, speech encoding and decoding, standardization, sound frame selection, endpoint detection, and noise filtering, but the present disclosure is not limited thereto.

The second operating system 6 includes a second virtual network port 61. The second virtual network port 61 is also a network interface, and the first virtual network port 51 is connected to the second virtual network port 61 by physical connection, such as secure digital input and output (SDIO), universal serial bus (USB), or serial peripheral port (SPI).

Through the physical connection between the first virtual network port 51 and the second virtual network port 61, there is no need to define a private protocol between the first operating system 5 and the second operating system 6, and data can be transmitted in both directions.

When the second operating system 6 receives the plurality of image data packets D1 and the plurality of voice data packets D2 from the first operating system 5, the second operating system 6 is configured to perform data distribution on the plurality of image data packets D1 and the plurality of voice data packets D2.

Specifically, the first operating system 5 and the second operating system 6 respectively correspond to different network addresses. The storage circuit 3 stores a default image type F1 and a default voice type F2. The default image type F1 is, for example, BMP, GIF, JPEG, PNG, WMF, or SVG, and the default voice type F2 is, for example, WAV, MP3, MP4, FLAC, APE, or ALAC, but the present disclosure is not limited thereto.

The second operating system 6 also includes a virtual bridge node 62. The first operating system 5 transmits the image data packets D1 to the second operating system 6. The virtual bridge node 62 collects the image data packets D1. The virtual bridge node 62 is configured to determine the port record of each of image data packets D1. When the port record of the image data packet D1 indicates that a destination of the image data packet D1 is the second operating system 6, the virtual bridge node 62 transmits the image data packet D1 to the second operating system 6. When the port record of the image data packet D1 indicates that the destination of the image data packet D1 is the remote device R, the virtual bridge node 62 transmits the image data packet D1 to the remote device R via the external network N.

The first operating system 5 transmits the voice data packets D2 to the second operating system 6. The virtual bridge node 62 collects the voice data packets D2. The virtual bridge node 62 is configured to determine the port record of each of the voice data packets D2. When the port record indicates that a destination of the voice data packet D2 is the second operating system 6, the virtual bridge node 62 transmits the voice data packet D2 to the second operating system 6. When the port record indicates that the destination of the voice data packet D2 is the remote device R, the virtual bridge node 62 transmits the voice data packet D2 to the remote device R via the external network N.

By determining the port record of the data packet, the distribution of data packets can be achieved. For example, a BMP type image has larger bytes and higher image quality, and a JPEG type image has smaller bytes and lower image quality. When the port record of the JPEG type image indicates that the destination of the JPEG type image is the remote device R, the virtual bridge node 62 transmits the JPEG type image to the remote device R. Since the JPEG type image has smaller bytes, the remote device R can receive the JPEG type image more quickly.

For example, a WAV type voice has smaller bytes and poorer sound quality, and a MP3 type voice has higher bytes and higher sound quality. When the port record of the WAV type voice indicates that the destination of the WAV type voice is the remote device R, the virtual bridge node 62 transmits the WAV type voice to the remote device R. Since the WAV type voice has smaller bytes, the remote device R can receive the voice data packet D2 more quickly.

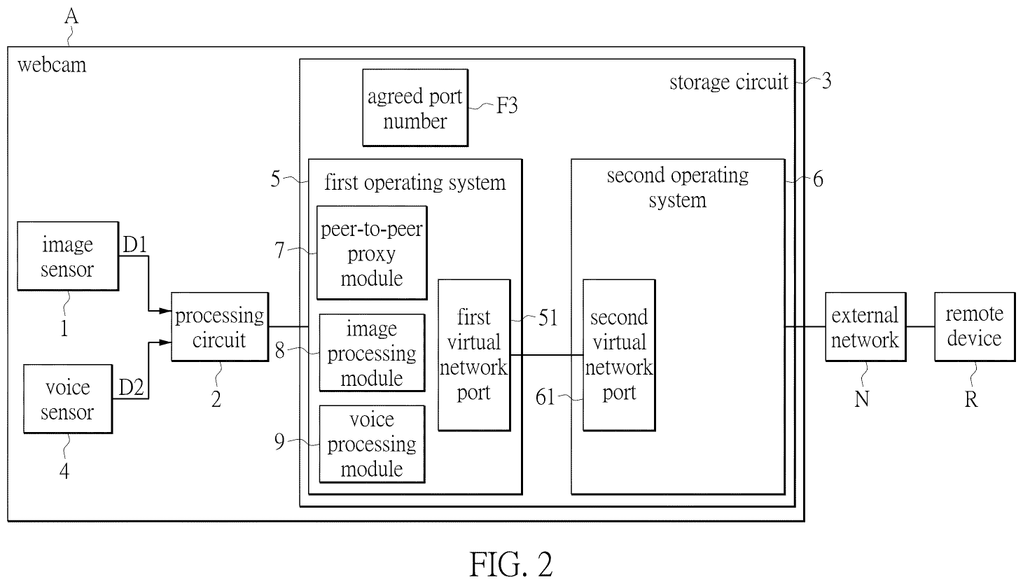

FIG. 2 is a schematic diagram of the webcam according to a second embodiment of the present disclosure. The webcam of FIG. 2 is compared with the webcam of FIG. 1, and the differences are as follows.

The first operating system 5 and the second operating system 6 each correspond to a same network address. Each of data packets has a port number, and the port number is usually a 16-bit number, but is not limited thereto. The storage circuit 3 stores an agreed port number F3.

For example, the first network data packets include the image data packets D1 respectively, the second operating system 6 is configured to determine whether the port number of each of the image data packets D1 conforms to the agreed port number F3. When the port number of the image data packet D1 conforms to the agreed port number F3, the image data packet D1 is transmitted to the second operating system 6. When the port number of the image data packet DI does not conform to the agreed port number F3, the second operating system 6 transmits the image data packet D1 to the remote device R.

For example, the second operating system 6 is configured to determine whether the port number of each of the voice data packets D2 conforms to the agreed port number F3. When the port number of the voice data packet D2 conforms to the agreed port number F3, the voice data packet D2 is transmitted to the second operating system 6. When the port number of the voice data packet D2 does not conform to the agreed port number F3, the second operating system 6 transmits the voice data packet D2 to the remote device R.

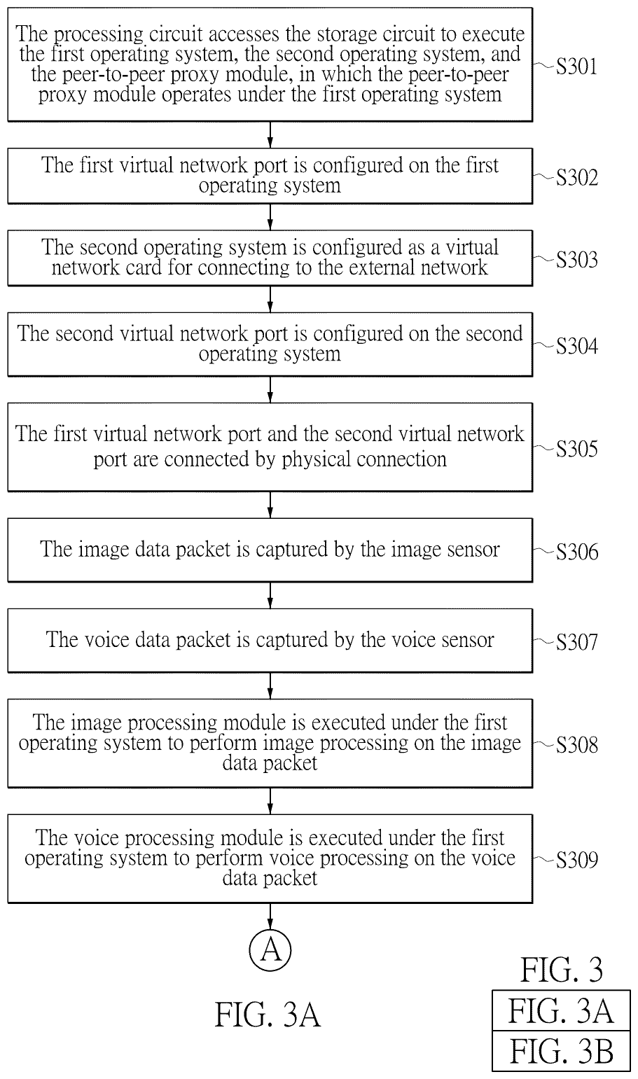

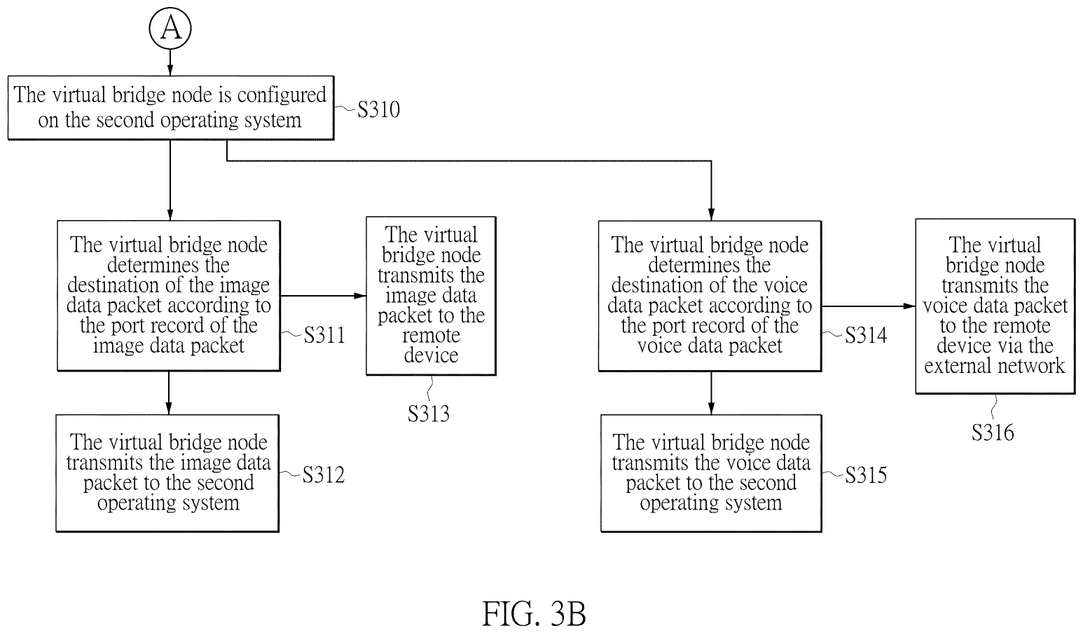

FIGS. 3A and 3B show a flowchart of a data processing method of the webcam according to the first embodiment of the present disclosure. The data processing method includes configuring the processing circuit 2 to access the storage circuit 3 for performing the following steps.

Reference is made to FIG. 3A. In step S301, the processing circuit 2 accesses the storage circuit 3 to execute the first operating system 5, the second operating system 6, and the peer-to-peer proxy module 7, in which the peer-to-peer proxy module 7 operates under the first operating system 5.

In step S302, the first virtual network port 51 is configured on the first operating system 5.

In step S303, the second operating system 6 is configured as a virtual network card for connecting to the external network N.

In step S304, the second virtual network port 61 is configured on the second operating system 6.

In step S305, the first virtual network port 51 and the second virtual network port 61 are connected by physical connection.

In step S306, the image data packet D1 is captured by the image sensor 1.

In step S307, the voice data packet D2 is captured by the voice sensor 4.

In step S308, the image processing module 8 is executed under the first operating system 5 to perform image processing on the image data packet D1. The image processing includes one or any combination of image enhancement, image encoding and decoding, image wavelet processing, resolution processing, color processing, and object recognition.

In step S309, the voice processing module 9 is executed under the first operating system 5 to perform voice processing on the voice data packet D2. The voice processing includes one or any combination of speech quantization, speech encoding and decoding, normalization, sound frame selection, endpoint detection, and noise filtering.

Reference is made to FIG. 3B. In step S310, the virtual bridge node 62 is configured on the second operating system 6.

In step S311, the virtual bridge node 62 determines the destination of the image data packet D1 according to the port record of the image data packet D1.

When the port record of the image data packet D1 indicates that the destination of the image data packet D1 is the second operating system 6, step S311 is followed by step S312.

When the port record of the image data packet D1 indicates that the destination of the image data packet D1 is the remote device R, step S311 is followed by step S313.

In step S312, the virtual bridge node 62 transmits image data packet D1 to the second operating system 6.

In step S313, the virtual bridge node 62 transmits the image data packet D1 to the remote device R.

In step S314, the virtual bridge node 62 determines the destination of the voice data packet D2 according to the port record of the voice data packet D2.

When the port record of the voice data packet D2 indicates that the destination of the voice data packet D2 is the second operating system 6, step S314 is followed by step S315.

When the port record of the voice data packet D2 indicates that the destination of the voice data packet D2 is the remote device R, step S314 is followed by step S316.

In step S315, the virtual bridge node 62 transmits the voice data packet D2 to the second operating system 6.

In step S316, the virtual bridge node 62 transmits the voice data packet D2 to the remote device R via the external network N.

In other embodiment, when the second operating system 6 receives data packet from the remote device R, the virtual bridge node 62 determines the destination of the data packet according to the port record of the data packet. When the port record indicates that the destination of the data packet is the second operation system 6, the virtual bridge node 62 transmits the data packet to the second operation system 6. When the port record of the data packet indicates that the destination is the first operation system 5, the virtual bridge node 62 transmits the data packet to the first operation system 5 via the second virtual network port 61.

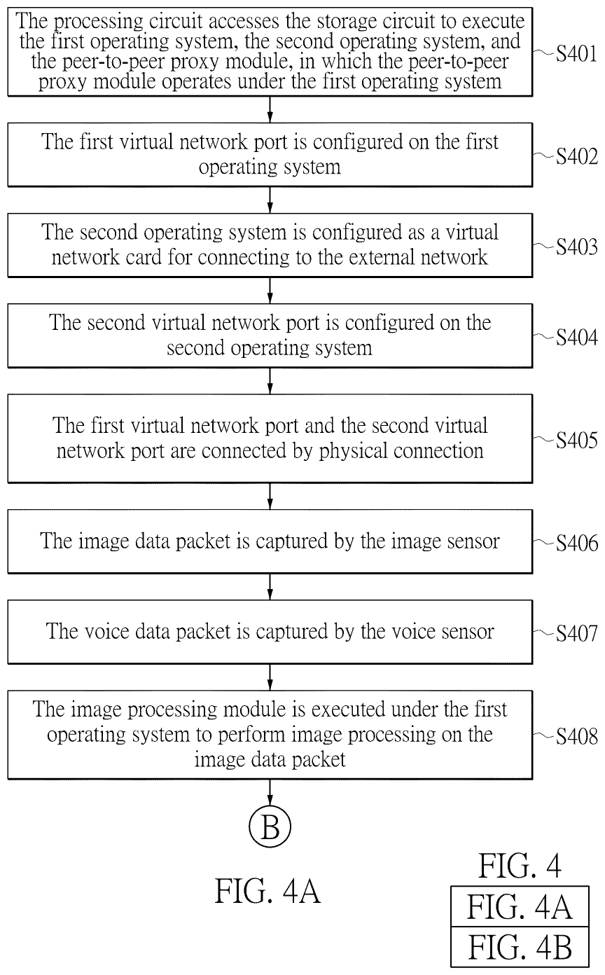

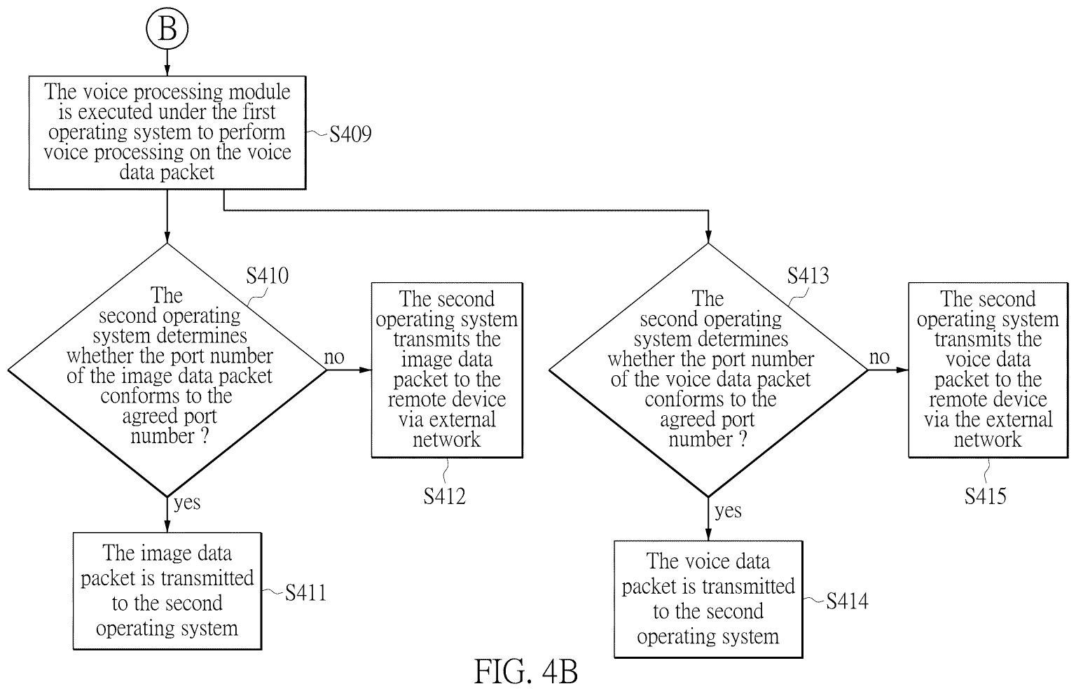

FIGS. 4A and 4B show a flowchart of the data processing method of the webcam according to the second embodiment of the present disclosure. The data processing method includes configuring the processing circuit 2 to access the storage circuit 3 for performing the following steps.

Reference is made to FIG. 4A. In step S401, the processing circuit 2 accesses the storage circuit 3 to execute the first operating system 5, the second operating system 6, and the peer-to-peer proxy module 7, in which the peer-to-peer proxy module 7 operates under the first operating system 5.

In step S402, the first virtual network port 51 is configured on the first operating system 5.

In step S403, the second operating system 6 is configured as a virtual network card for connecting to the external network N.

In step S404, the second virtual network port 61 is configured on the second operating system 6.

In step S405, the first virtual network port 51 and the second virtual network port 61 are connected by physical connection.

In step S406, the image data packet D1 is captured by the image sensor 1.

In step S407, the voice data packet D2 is captured by the voice sensor 4.

In step S408, the image processing module 8 is executed under the first operating system 5 to perform image processing on the image data packet D1.

Reference is made to FIG. 4B. In step S409, the voice processing module 9 is executed under the first operating system 5 to perform voice processing on the voice data packet D2.

In step S410, the second operating system 6 determines whether the port number of the image data packet D1 conforms to the agreed port number F3.

When the port number of the image data packet D1 conforms to the agreed port number F3, step S410 is followed by step S411.

When the port number of the image data packet D1 does not conform to the agreed port number F3, step S410 is followed by step S412.

In step S411, the image data packet D1 is transmitted to the second operating system 6.

In step S412, the second operating system 6 transmits the image data packet D1 to the remote device R via external network N.

In step S413, the second operating system 6 determines whether the port number of the voice data packet D2 conforms to the agreed port number F3.

When the port number of the voice data packet D2 conforms to the agreed port number F3, step S413 is followed by step S414.

When the port number of the voice data packet D2 does not conform to the agreed port number F3, step S413 is followed by step S415.

In step S414, the voice data packet D2 is transmitted to the second operating system 6.

In step S415, the second operating system 6 transmits the voice data packet D2 to the remote device R via the external network N.

### Beneficial Effects of the Embodiments

In conclusion, in the webcam and the data processing method thereof provided by the present disclosure, there is no need to additionally define a private protocol between the first operating system and the second operating system, and bidirectional data transmission can also be performed between the first operating system and the second operating system. Since the peer-to-peer proxy module does not operate under the second operating system, the second operating system is only responsible for the network card function. In this way, the division of labor between the first operating system and the second operating system is clear, which can reduce development difficulties and shorten a development cycle.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A webcam, comprising:
a storage circuit; and
a processing circuit electrically connected to the storage circuit;
wherein the processing circuit accesses the storage circuit to execute a first operating system, a second operating system, and a peer-to-peer proxy module, the first operating system collects a plurality of data packets, the peer-to-peer proxy module operates under the first operating system, and the second operating system is configured to act as a virtual network card for connecting to an external network;
wherein the first operating system includes a first virtual network port, the second operating system includes a second virtual network port, and the first virtual network port is connected to the second virtual network port.

2. The webcam according to claim 1, wherein a type of the first virtual network port is a secure digital input/output port, a universal serial bus, or a serial peripheral port, and a type of the second virtual network port is the same as the type of the first virtual network port.

3. The webcam according to claim 1, wherein the processing circuit further accesses the storage circuit to execute an image processing module, and the image processing module operates under the first operating system to perform image processing on the data packets.

4. The webcam according to claim 3, wherein the image processing includes one or any combination of image enhancement, image encoding, image decoding, image wavelet processing, resolution processing, color processing, and object recognition.

5. The webcam according to claim 1, wherein the processing circuit further accesses the storage circuit to execute a voice processing module, and the voice processing module operates under the first operating system to perform voice processing on the data packets.

6. The webcam according to claim 5, wherein the voice processing includes one or any combination of speech quantization, speech encoding, speech decoding, standardization, sound frame selection, endpoint detection, and noise filtering.

7. The webcam according to claim 1, wherein the second operating system further includes a virtual bridge node, and the virtual bridge node is configured to determine a destination of each of the data packets according to a port record of the data packet; wherein, when the port record of the data packet indicates that the destination of the data packet is the second operating system, the virtual bridge node transmits the data packet to the second operating system; wherein, when the port record of the data packet indicates that the destination of the data packet is a remote device, the virtual bridge node transmits the data packet to the remote device via the external network.

8. The webcam according to claim 7, wherein the first operating system and the second operating system respectively correspond to different network addresses.

9. The webcam according to claim 1, wherein the second operating system is configured to determine whether or not a port number of each of the data packets conforms to an agreed port number; wherein, when the port number of the data packet conforms to the agreed port number, the data packet is transmitted to the second operating system; wherein, when the port number of the data packet does not conform to the agreed port number, the second operating system transmits the data packet to a remote device via the external network.

10. The webcam according to claim 9, wherein the first operating system and the second operating system each correspond to a same network address.

11. A data processing method of a webcam, comprising:
configuring a processing circuit to access a storage circuit for execution of a first operating system, a second operating system, and a peer-to-peer proxy module, wherein the peer-to-peer proxy module operates under the first operating system;
collecting, by the first operating system, a plurality of data packets;
configuring a first virtual network port on the first operating system;
configuring the second operating system as a virtual network card for connecting to an external network;
configuring a second virtual network port on the second operating system; and
connecting the first virtual network port and the second virtual network port.

12. The data processing method according to claim 11, wherein a type of the first virtual network port is a secure digital input/output port, a universal serial bus, or a serial peripheral port, and a type of the second virtual network port is the same as the type of the first virtual network port.

13. The data processing method according to claim 11, further comprising: configuring the processing circuit to access the storage circuit, so as to execute an image processing module under the first operating system; wherein the image processing module performs image processing on the data packets.

14. The data processing method according to claim 13, wherein the image processing includes one or any combination of image enhancement, image encoding, image decoding, image wavelet processing, resolution processing, color processing, and object recognition.

15. The data processing method according to claim 11, further comprising: configuring the processing circuit to access the storage circuit, so as to execute a voice processing module under the first operating system; wherein the voice processing module performs voice processing on the data packets.

16. The data processing method according to claim 15, wherein the voice processing includes one or any combination of speech quantization, speech encoding, speech decoding, standardization, sound frame selection, endpoint detection, and noise filtering.

17. The data processing method according to claim 11, further comprising: configuring a virtual bridge node on the second operating system; and determining, by the virtual bridge node, a destination of each of the data packets according to a port record of the data packet; wherein, when the port record of the data packet indicates that the destination of the data packet is the second operating system, the virtual bridge node transmits the data packet to the second operating system; wherein, when the port record of the data packet indicates that the destination of the data packet is a remote device,, the virtual bridge node transmits the data packet to the remote device via the external network.

18. The data processing method according to claim 11, further comprising: determining, by the second operating system, whether or not a port number of each of the data packets conforms to an agreed port number; wherein, when the port number of the data packet conforms to the agreed port number, the data packet is transmitted to the second operating system; wherein, when the port number of the data packet does not conform to the agreed port number, the second operating system transmits the data packet to a remote device via the external network.
